(19) United States
(12) Patent Application Publication
(10) Pub. No.: US 2015/0263664 A1
(43) Pub. Date: Sep. 17, 2015

(54) Solar Slate Plate

(71) Applicant: David Tomolillo, Medford, MA (US)

(72) Inventor: David Tomolillo, Medford, MA (US)

(21) Appl. No.: 14/658,956

(22) Filed: Mar. 16, 2015

Related U.S. Application Data
(60) Provisional application No. 61/953,401, filed on Mar. 14, 2014.
(60) Provisional application No. 61/993,806, filed on May 15, 2014.

(51) Int. Cl. H02S 20/23; H01L 31/042; H02S 20/26

(52) U.S. Cl. CPC H02S 20/23; H02S 20/26; H02S 40/00

(57) ABSTRACT

A slate solar panel installation system and method which allows users to install solar panels on their slate tile roofs wherein one slate tile is removed and the present invention is installed in its place. The current invention does not require drilling any holes in the slate tiles, therefore, not affecting the integrity of the roof and reducing the likelihood of leaks to near zero. The present invention is constructed from galvanized steel that will not bend under 120 mile an hour winds making the current invention extremely secure and usable in many different whether conditions. The present invention can be painted to match the color and style of the surrounding tiles, allowing the homeowner to remove the solar panels and rails and leave the present invention in place.

### CROSS REFERENCE TO RELATED APPLICATION

This application claims the benefit of and takes priority from U.S. Provisional Patent Application Ser. No. 61/953,401 filed on Mar. 14, 2014, and from U.S. Provisional Patent Application Ser. No. 61/993,806 filed on May 15, 2014 the contents of which are hereby incorporated by reference.

### BACKGROUND OF THE INVENTION

1. Field of the Invention

The present invention relates to a plate designed for the application of solar panels to slate roofs and the installation method for such plate.

2. Description of the Related Art

Solar power has become an increasingly popular energy alternative. More and more people are turning to solar power as a more ecofriendly and efficient power source. Energy conscience people have installed solar panels to the roofs of their homes in order for their homes to be run on solar power.

There are certain roofing materials that make the installation of solar panels more difficult. One such roofing material is slate. The current solar panel application kits and methods to slate roofs require drilling holes in the slate tiles themselves. However, this method is flawed and not practical.

Drilling holes in the slate tiles of one's roof threatens the integrity of the tiles, causing them to be more likely to crack or break. Furthermore, drilling holes in the slate tiles could lead to leaks in the roof because the holes allow rainwater and melting snow to get into places water should not be. Additionally, these other application kits and methods have multiple parts, such as rubber “O” rings that can pinch and leak, and have multiple overlapping sleeves.

### SUMMARY OF THE INVENTION

The instant apparatus, system and accompanying methods, as illustrated herein, is clearly not anticipated, rendered obvious, or even present in any of the prior art mechanisms, either alone or in any combination thereof. Therefore, it is an object of the instant invention to provide a plate designed for the application of solar panels to slate roofs and a method of installation of such plate.

It is a further object of the instant system and apparatus for the plate to be made of any of polymeric, metallic, alloy, composite, compound metallic-polymeric metal or composite within the state of the art.

It is a further object of the instant invention for the plate to be made of galvanized steel.

It is a further object of the instant invention for the plate to have an angle bracket secured to the topside of the plate to be attached to the solar panel mechanism.

It is a further object of the instant invention for the plate to have two pre-drilled holes at the top corners of the plate for stability and keeps plate from twisting during installation.

It is a further object of the instant invention for the plate to have a pre-cut slit that runs horizontally across the center of the plate to allow for varying placement needs for the structural and/or engineered screw that is to be drilled into the rafter.

Another embodiment of the instant invention is that the plate has no pre-cut slit across the center of the plate.

Another embodiment of the instant invention is that the plate has three pre-cut slits that run diagonally across the center of the plate to allow for various placement needs for the four-inch screw that is to be drilled into the rafter.

Another embodiment of the instant invention is that the plate contains an alternative bracket secured to the topside of the plate for the attachment of the solar panel mechanism.

An additional embodiment of the instant invention is that the plate is made of ¼″ 6061 aluminum and able to withstand wind gusts up to 120 miles an hour spaced 48″ apart. It is a more simplified revised plate that is universal to multiple mounting brackets. The aluminum embodiment is lighter and weighs almost the same as a piece of slate so the plates will not affect the engineering of the entire solar system.

It is a further object of the instant embodiment that there are two predrilled holes in the top corners 2″ on center. This is for quick installation of the product, which keeps it stable during installation of structural screw.

It is a further object of the instant embodiment that most exterior all weather screws can be used for the quick installation of the top corners to secure the plate. The 2-screws keep invention from twisting and/or racking prior to securing into the rafter.

It is a further object of the instant embodiment that it uses a flush mount stainless steel screw for effortless installation of most mounting brackets.

It is a further object of the instant embodiment that a small bead of aluminum silicone or rubber “O” ring around the screw is recommended.

The present system solves all of these issues of previous solar panel application kits to slate tiles. The current invention is attached to the roof as if one was replacing a slate tile on the roof. It is custom designed to the exact width and style of the existing slate tiles (8″, 10″ or 12″ sizes and rectangular, scallop or pyramid shapes). During the installation, one slate tile is removed and the present invention is installed in its place.

The current system does not require drilling any holes in the slate tiles, therefore, not affecting the integrity of the roof and reducing the likelihood of leaks, breaks or blow offs to near zero. Not only does this method maintain the integrity of the roof and tiles, it allows the homeowner to end up with several left over slate tiles in which the homeowner can save for future repairs.

Additionally, the present system is generally constructed from galvanized steel (or aluminum in an additional embodiment) that will not bend under 150 mile an hour winds and contains a four inch screw that is attached directly into a rafter. This makes the current invention extremely secure and usable in many different weather conditions.

Furthermore, the present system that replaces the existing slate tile can be painted to match the color and style of the surrounding tiles. Thus, if years later the customer decides to discontinue usage of the solar panels, the homeowner can remove the solar panels and rails and leave the current invention in place because it is the same color and shape and is watertight. Also, if the homeowner wants to remove the present invention from the roof after years, they will still have the excess tiles to reinstall.

Moreover, when the homeowner decides he does not desire or can't afford to remove the instant invention and replace it with the original slate, the owner can leave the current invention in place because as it is the same color and shape of the roof tiles and could also work as a snow damper.

In this respect, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

FIG. 1A is a top view of the invention;

FIG. 1B is a side view of the pre-cut slit located in the center of the plate;

FIG. 2A is an isolated view of the angled bracket;

FIG. 2B is a side view of the invention with a focus on the angle bracket;

FIG. 3 is perspective view of the invention;

FIGS. 4A and 4B are perspective views of an additional embodiment of the invention without a pre-cut center slit;

FIG. 5 is a top view of an additional embodiment of the invention with three pre-cut slits;

FIGS. 6A-6C are top and side views of the additional simplified embodiment;

FIGS. 7A and 7B are perspective views of another mounting bracket embodiment of the instant invention;

FIGS. 8A and 8B are perspective views of another mounting bracket embodiment of the instant invention;

FIGS. 9A and 9B are perspective views of another mounting bracket embodiment of the instant invention;

FIGS. 10A and 10B are perspective views of another mounting bracket embodiment of the instant invention, and

FIG. 11 illustrates another perspective view of another mounting bracket embodiment of the instant invention.

### DETAILED DESCRIPTION OF THE SEVERAL EMBODIMENTS

The detailed description set forth below is intended as a description of presently preferred embodiments of the invention and does not represent the only forms in which the present invention may be construed and/or utilized. The description sets forth the functions and the sequence of the steps for producing the system and accompanying apparatus. However, it is to be understood that the same or equivalent functions and sequences may be accomplished by different embodiments also intended to be encompassed within the scope of the invention.

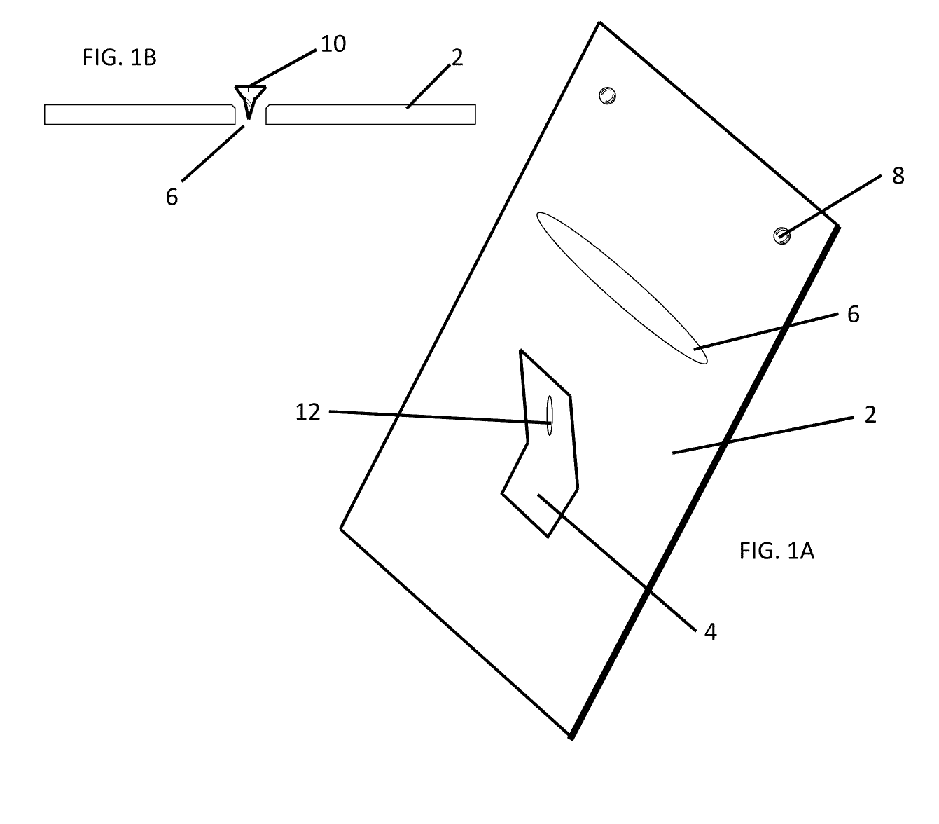

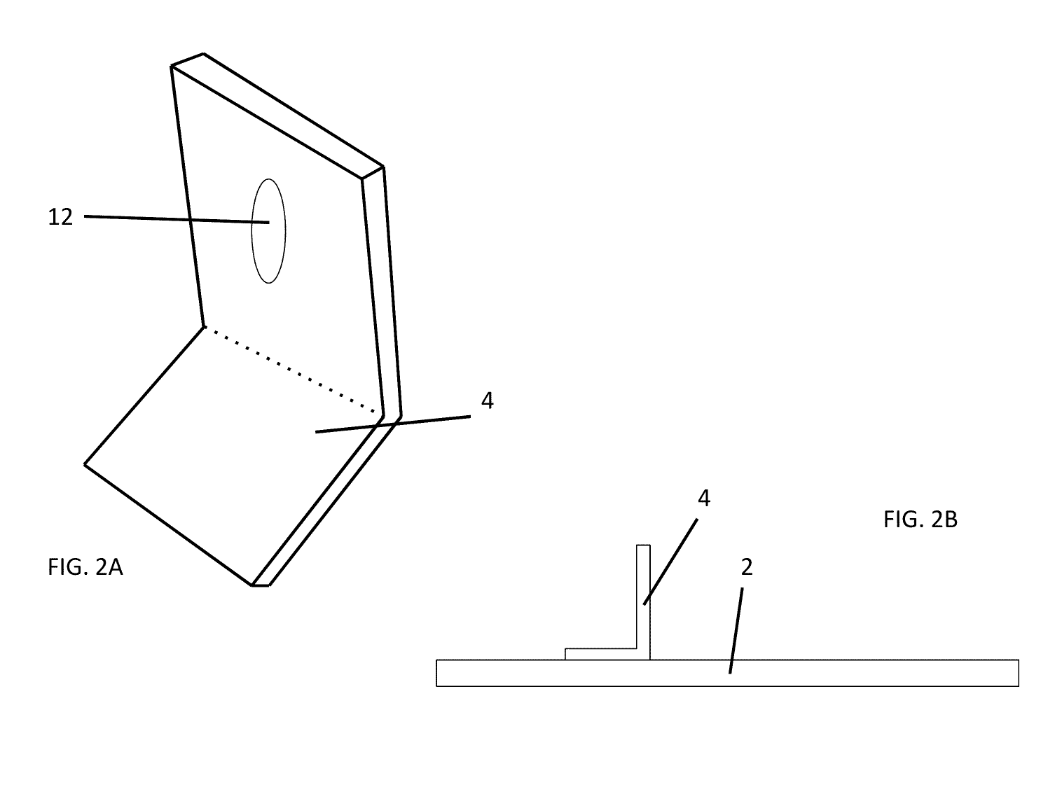

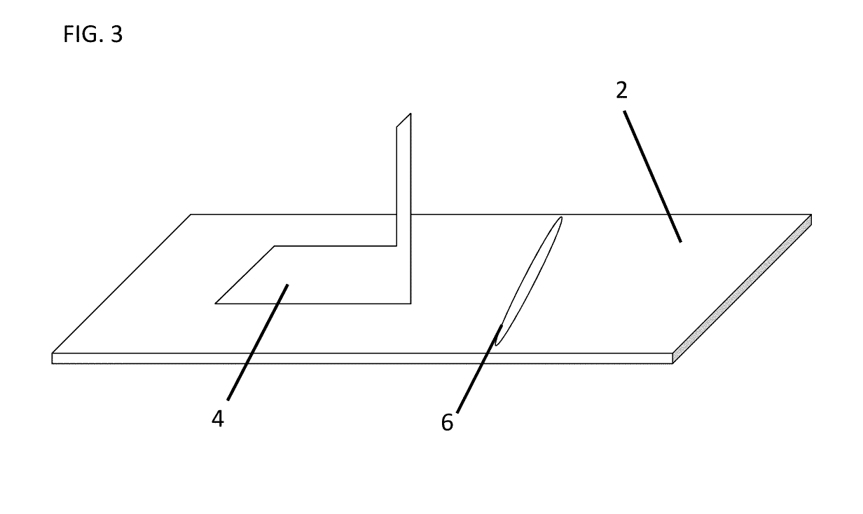

FIGS. 1A-3 depicts the present invention, which includes a rectangular steel plate 2. The rectangular plate 2 has a right angle bracket 4 with a pre-cut oval shaped hole 12 on the leg of the bracket that is perpendicular to the plate 2. The pre-cut oval shaped hole 12 is used to secure the plate to be attached to the solar panel mechanism.

The rectangular plate 2 has two pre-drilled holes 8 at the top corners of the plate 2 for stability and twisting. Also, the rectangular plate 2 has a pre-cut slit 6 that runs horizontally across the center of the plate to allow for various placement needs for the four-inch screw 10 that is to be drilled into the rafter.

To install the present invention, the rafters have to be inspected and the roof deck has to be engineered to withstand the weight. Just like installing solar panels on a traditionally shingled roof, the location of the rafters has to be identified.

Before installation, the solar array is mapped out on the roof. Once the selected slates are determined a diamond pattern of slate tiles has to be removed over the rafter that is to be drilled into. In the lower row of the pattern one tile is removed, (this is where the SSP is installed), two from the middle row, and one from the top row.

Then place the plate 2 at the bottom of the diamond pattern and screw two 1½″×#10 wood screws through the pre-drilled holes 8 at the top corners of the plate. Next, drill a 1/4″ pilot hole directly over the rafter, bore plate accordingly to accept desire flush mount screw and secure the engineered wood screw 10 directly into the rafter through the pre-cut slit 6. The 4 inch screw placement can vary up to 8 inches over the width of the tile based on the location of the pre-cut slit or slot 6. A #13 or any other engineered screw that meets engineer and code requirements may be utilized.

Then reinstall the two original slate shingles to the middle row and nail the slate in the standard location and fashion. As a result, there is an additional slate tile that is spared during the process.

The top row or last piece can be reinstalled in a few ways depending upon the method used by the slate roofing professional.

The plate 2 can be painted to match the existing slate color and style of the tiles.

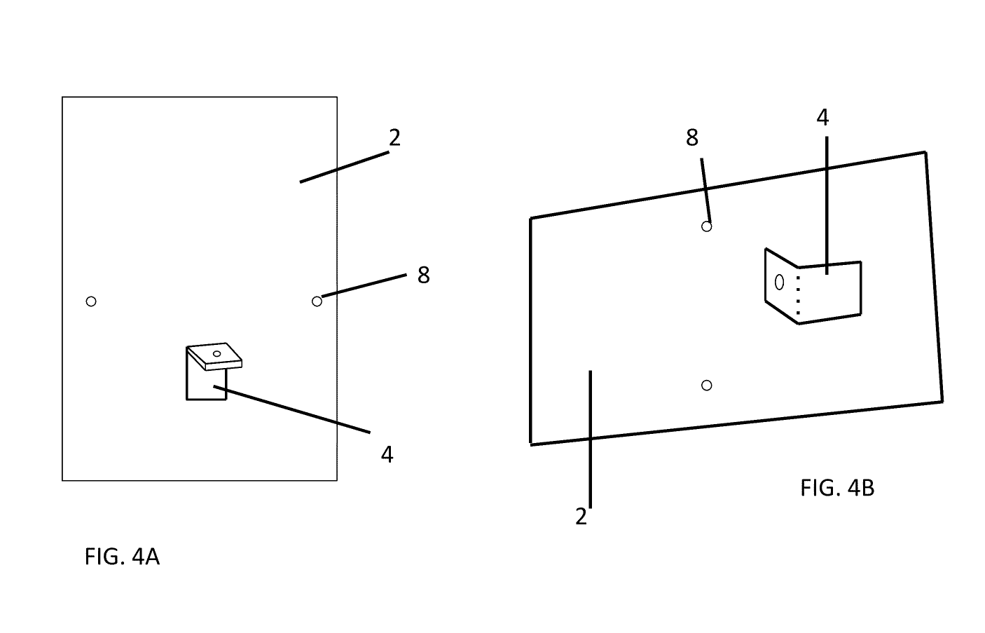

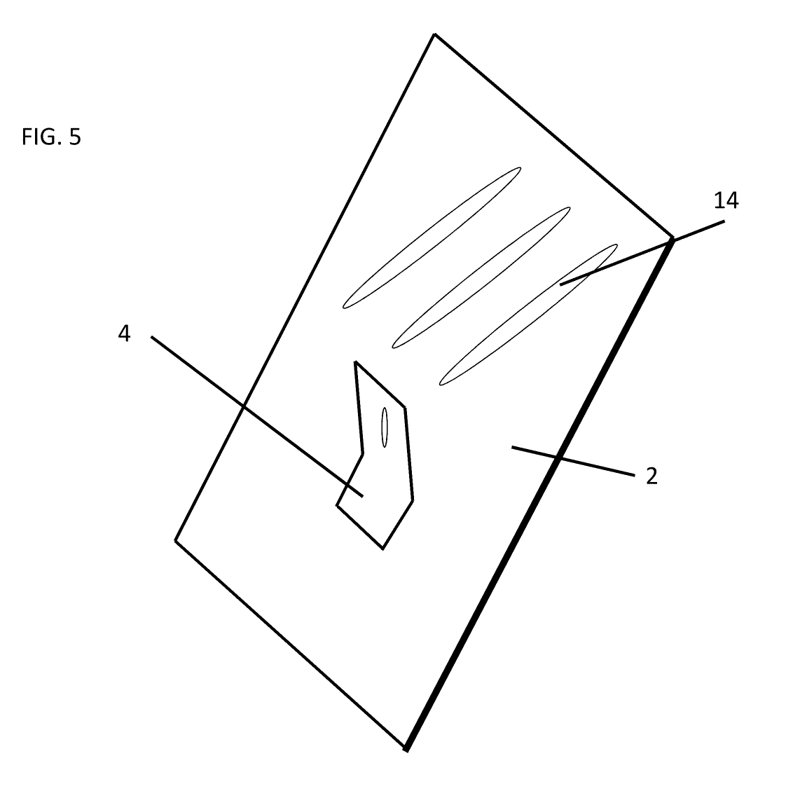

FIGS. 4A and 4B depict an additional embodiment of the present invention and its components. In this embodiment, the rectangular plate 2 has no pre-cut slit and the pre-drilled holes 8 are moved from the top of the plate 2 to the center. This is to accommodate different roof and tile placement locations.

FIG. 5 depicts an additional embodiment of the present invention and its components. In this embodiment, the plate 2 has three pre-cut slits 14 that run diagonally across the center of the plate 2 to allow for various placement needs for the four-inch screw 10 that is to be drilled into the rafter.

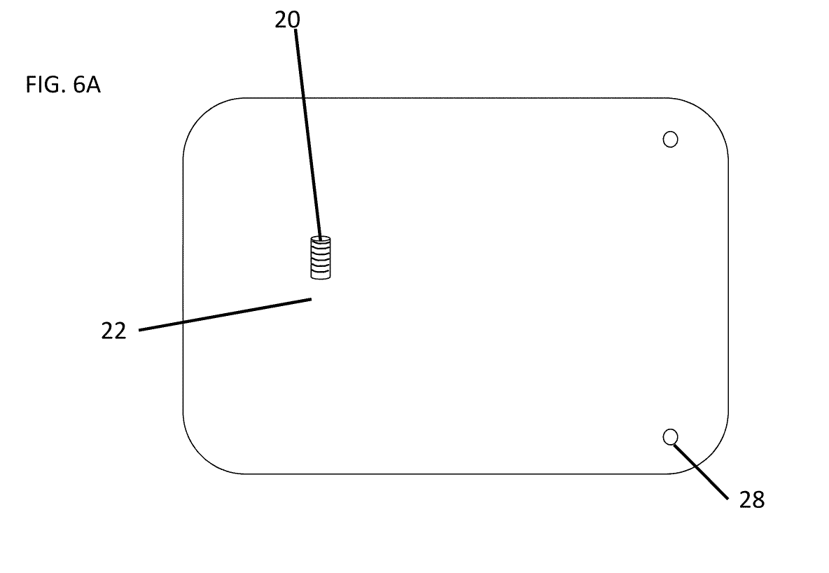

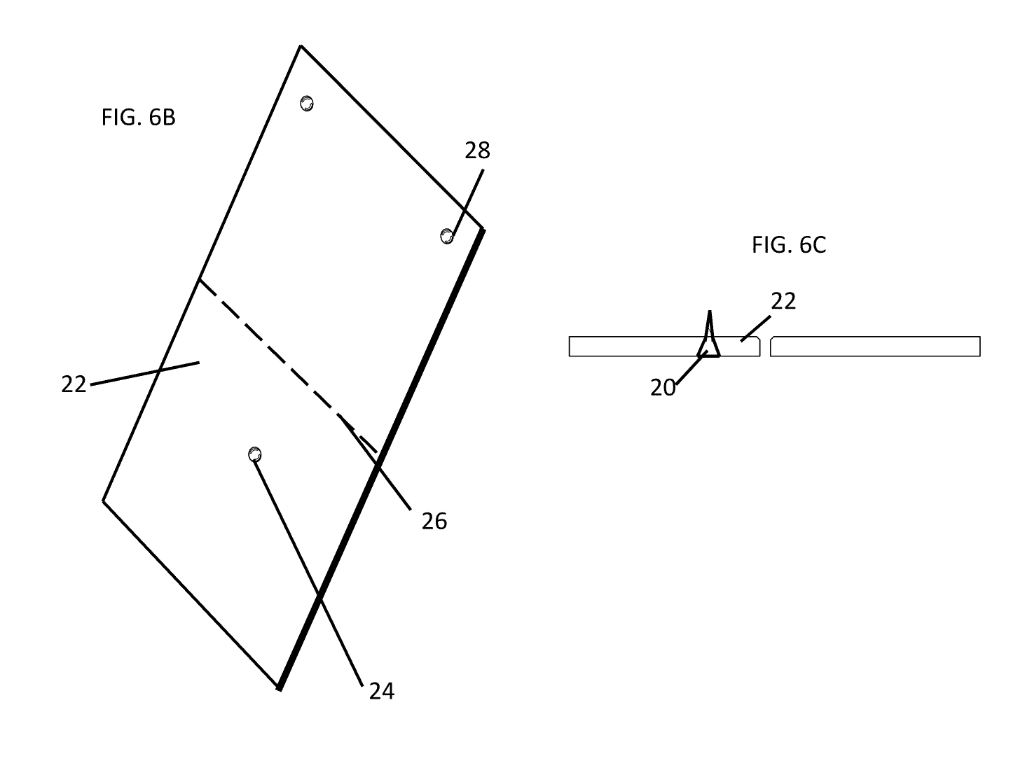

FIGS. 6A-6C depicts an additional embodiment of the present invention. It is a simplified version of the present invention made of aluminum. In the embodiment, the plate 22 has two pre-drilled holes 28 in the top corners 2″ on center of the plate 22. This is for quick installation of the product and most exterior all weather screws can be used to secure the plate. The two screws keep the plate 22 from twisting and/or racking prior to securing into the rafter.

The plate 22 also has a pre-cut hole 24 in the middle of the left half of the plate center 26. A stainless steel screw 20 is placed through this pre-cut hole 24 for effortless installation of most mounting brackets. The use of a small bead of aluminum silicone or rubber “O” ring around the screw is recommended. Since the product is made out of aluminum on site drilling into the rafter is much easier than other metals. The user should be sure to burr, countersink or bevel the onsite hole so that the engineered screw used sits flush.

In embodiments utilizing steel construction, a center screw which will be tapped may be utilized. Within this embodiment, the protruding screw may be grinded and welded underneath. The threaded screw may utilize 3/16 steel instead of ¼ inch steel and there will be two apertures in top corner and one screw in the rafter, which may be a ¼ inch 6061

To install this additional embodiment of the present invention, once the solar system is laid out, like above, identify approximately where the rafters are located. Then remove a three-row diamond pattern of slate shingles over rafter area. Once the diamond pattern is removed the rafter location will be easily identified. Then install the plate 22 (at the bottom row of the diamond pattern) using the two easy mount screws in the pre-cut top corners 28 to keep the plate 22 from twisting during on site drilling. Identify where the rafter is and drill a ¼″ pilot hole directly through the plate 22 and into the rafter. Once this is done bur the pilot hole so that the stainless steel screw 20 lays flush on the face of the plate 22.

It must be noted that there are many styles and exposures of slate shingles and this will depend where the engineered wood screw be placed. For example, if the slate the is twelve (12) feet wide by eighteen (18) inches in thickness, then the screw will be placed ten (10) inches from the bottom, which is just above the top of the tile below it.

Then install the remaining two rows of slates as they would. normally be installed. Lastly, continue installation of the instant, invention, according to plans, to the rest of the roof.

It is preferred for this embodiment that the instant invention be spaced 48 inches apart for inland adaptations and 32 inches apart coastal adaptations. Furthermore, the instant embodiment may be engineered and constructed to withstand up 105 MPH coastal wind speeds and 120115 MPH inland, wind speeds. The preferred screw for installation of the instant embodiment may include a Fasten Master Headlock HLGM334.

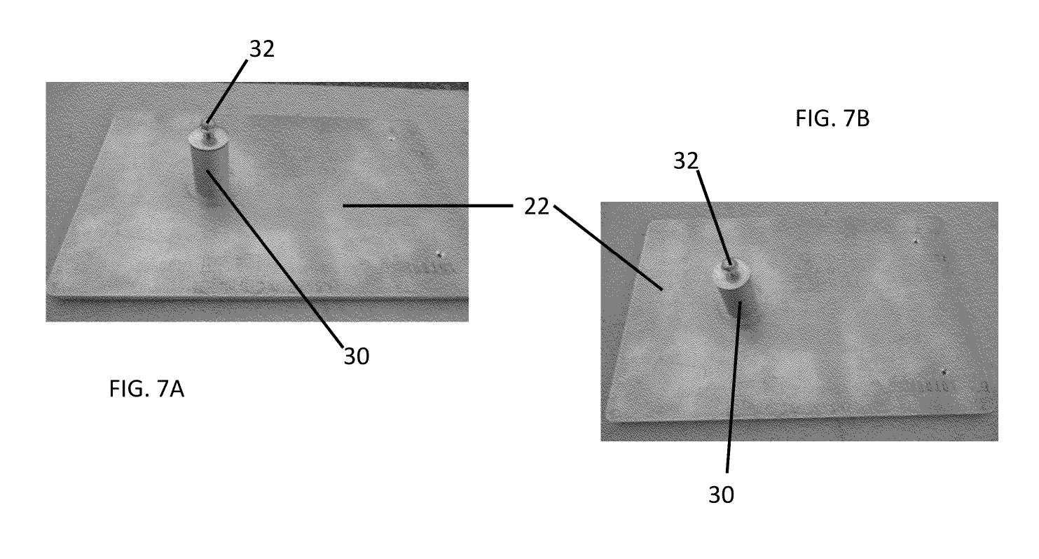

FIGS. 7A and 7B depicts an additional embodiment of the bracket that can be attached to the plate 22, for the instant invention to be affixed to the solar panels being installed. The embodiment contains a cylindrical mechanism 30 with a screw 32 through its center to which the solar panels can be affixed to.

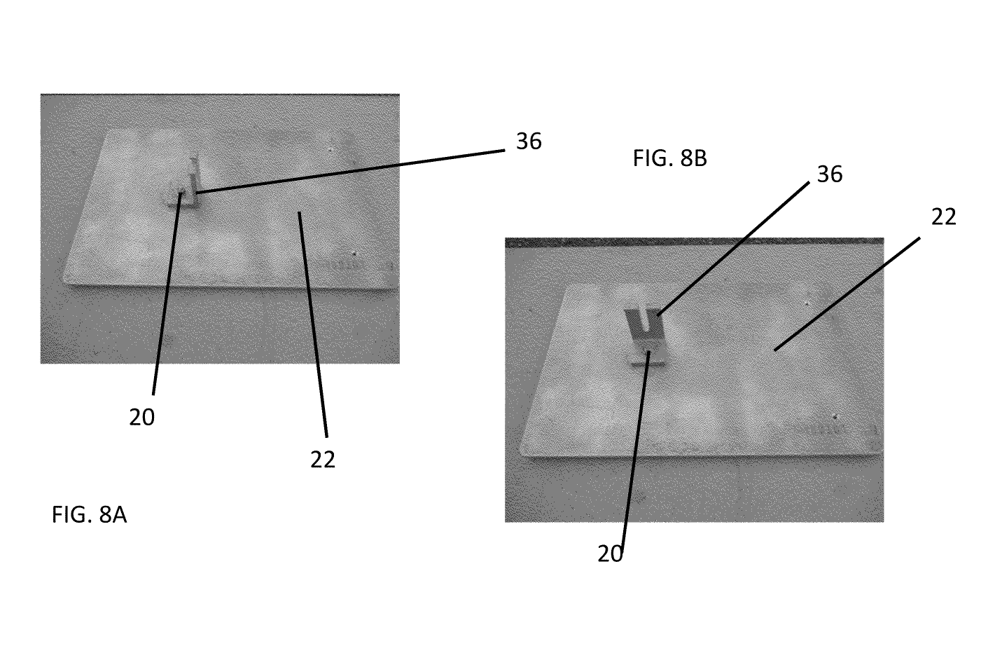

FIGS. 8A and 8B depicts an additional embodiment of the bracket that can be attached to the plate 22, for the instant invention to be affixed to the solar panels being installed. The embodiment contains an open ended bracket 36 with a screw 20 through its bottom half to which the solar panels can be affixed to.

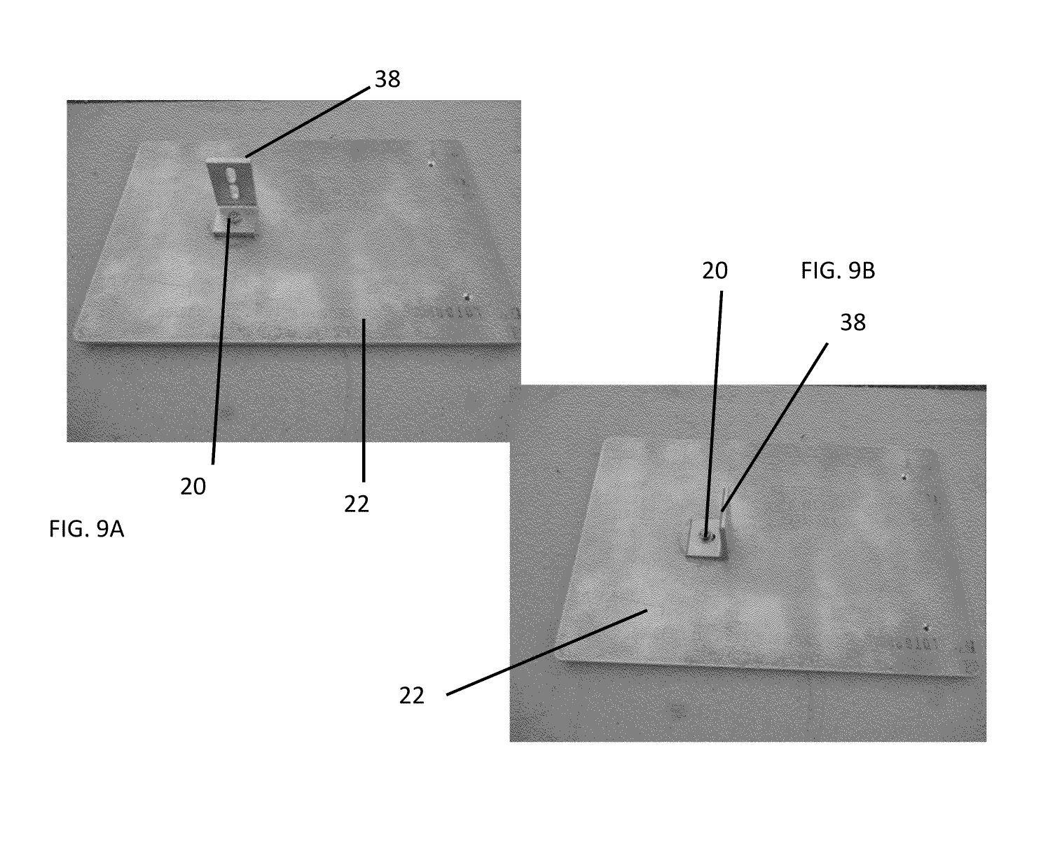

FIGS. 9A and 9B depicts an additional embodiment of the bracket that can be attached to the plate 22, for the instant invention to be affixed to the solar panels being installed. The embodiment contains a double holed bracket 38 with a screw 20 through its bottom half to which the solar panels can be affixed to.

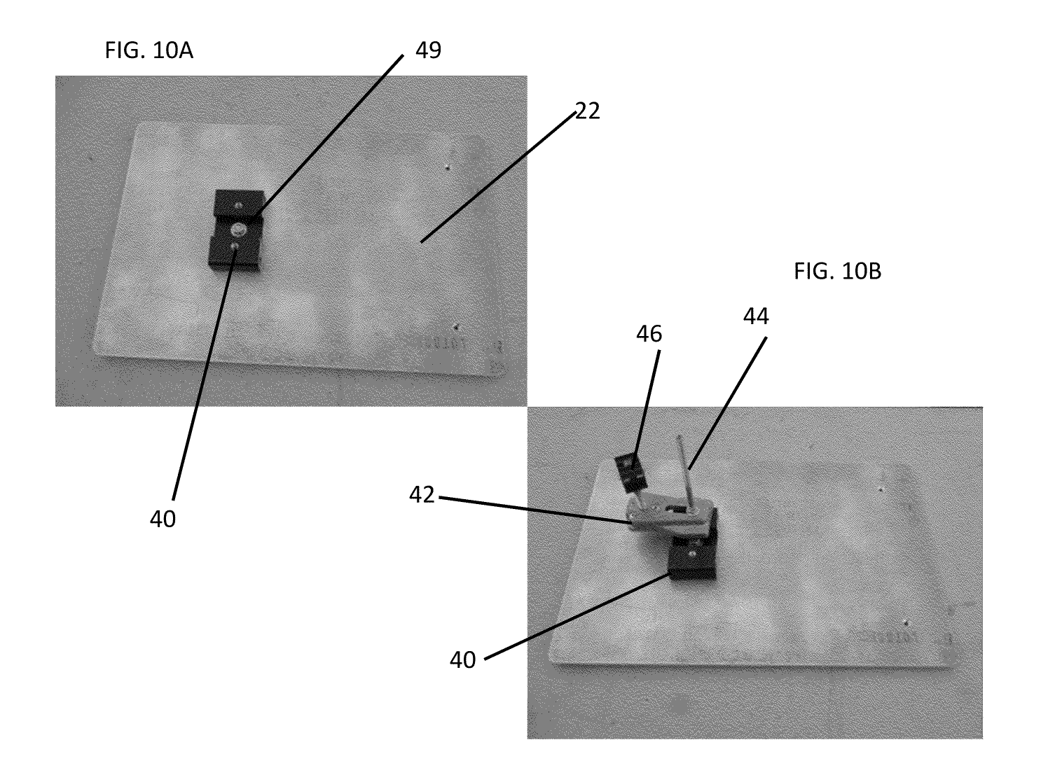

FIGS. 10A and 10B depicts an additional embodiment of the bracket that can be attached to the plate 22, for the instant system to be affixed to and retain the solar panels being installed. The embodiment contains a base mounting bracket 40 comprising a compressed mid-section wherein an adjustment mechanism 44 such as a screw, bolt or other such mechanism known in the art, is allowed to pass through an aperture in the center of the base mounting bracket 40 and the compressed mid-section. An additional bracket 42 is threaded onto the adjustment mechanism 44 so that it is perpendicular to the first bracket 40. The second bracket 42 has a mounting mechanism 46 affixed to the end not threaded onto the screw 44. The end of the adjustment mechanism 44 and the mounting mechanism 46 are then utilized to attach the plate 22 to the solar panels being installed.

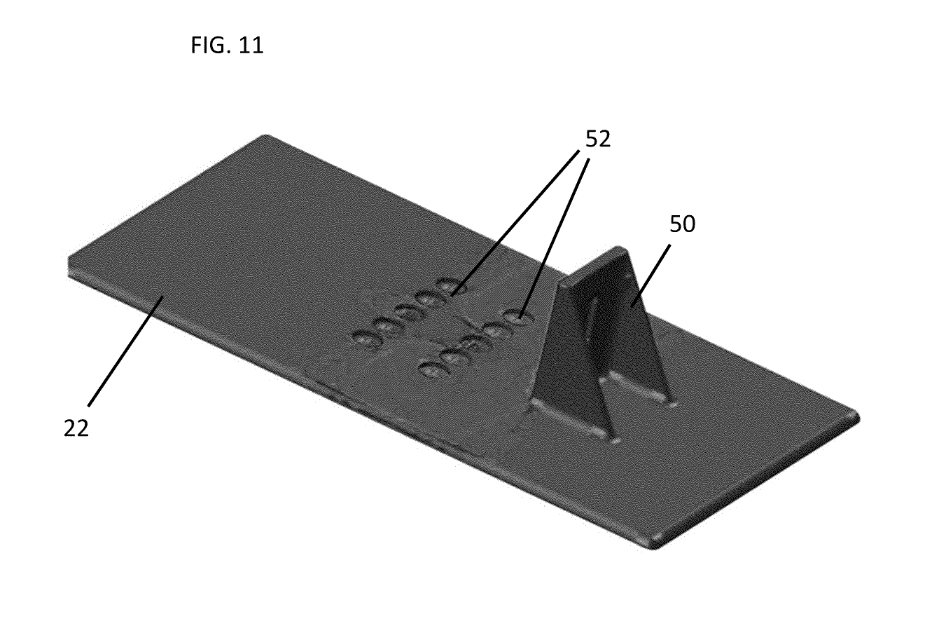

FIG. 11 depicts an additional embodiment of the bracket that van be attached to the plate 22, for the instant system to be affixed to and retain the solar panels being installed. The embodiment contains a base mounting bracket 50 that is welded to the base plate 22. The embodiment also contains a set of apertures on the base plate 52 utilized to attach the plate 22 to the solar panels being installed.

In a further embodiment, a center screw ( 5/16 or ⅜) is drilled and tapped in order to alleviate rotation or spinning of the screw during installation of other mounting brackets.

A further embodiment is to be able to pre-drill the aluminum plate on site using a special flush mount bit to use a Simpson SDW 22438 structural wood screw.

There has thus been outlined, rather broadly, the more important features of solar slate plate in order that the detailed description thereof that follows may be better understood, and in order that the present contribution to the art may be better appreciated. There are additional features of the system that will be described hereinafter and which will form the subject matter of the claims appended hereto.

What is claimed is:

1. A system for the application of solar panels to slate roofs comprising:
a rectangular plate comprising an upper side and a lower side;
an angled bracket;
a set of pre-drilled apertures; and
a pre-cut center slit.

2. The system for the application of solar panels to slate roofs of claim 1 wherein the angled bracket comprises a right-angled bracket attached to the upper side of the rectangular plate.

3. The system for the application of solar panels to slate roofs of claim 2 wherein the angled bracket comprises a pre-cut oval shaped aperture on a portion of the angled bracket that is perpendicular to the rectangular plate.

4. The system for the application of solar panels to slate roofs of claim 1 wherein the rectangular plate comprises two pre-drilled apertures at top corners of the rectangular plate for placement of screws to allow for stability and twisting.

5. The system for the application of solar panels to slate roofs of claim 1, wherein the rectangular plate comprises a pre-cut slit that runs horizontally across a center of the plate to allow for various placement needs for a four-inch screw that is to be drilled into the rafter.

6. An apparatus for retaining peripherals on a roof comprising:
a rectangular plate;
at least two pre-drilled mounting apertures; and
an angle bracket.

7. The apparatus for retaining peripherals on a roof of claim 6, wherein the rectangular plate comprises no pre-cut slit and the two pre-drilled holes are moved from the top of the plate to the center in order to accommodate different roof and tile placement locations.

8. The apparatus for retaining peripherals on a roof of claim 6, wherein the rectangular plate comprises at least three pre-cut slits that run diagonally across a center of the rectangular plate.

9. A system for fastening solar panels to a slate roof comprising:
a rectangular plate comprising an upper side and a lower side;
at least two bracket members; and
a set of pre-drilled apertures.

10. The system for fastening solar panels to a slate roof of claim 9 wherein the set of pre-drilled apertures comprises a first pre-drilled aperture at a first upper corner and a second pre-drilled aperture at a second upper corner of the plate for the placement of fastening mechanism to enhance stability and resist rotational moments.

11. The system for fastening solar panels to a slate roof of claim 9, wherein the rectangular plate comprises a pre-cut aperture in a central area of the left half of the plate center.

12. The system for fastening solar panels to a slate roof of claim 9, further comprising a stainless steel fastener disposed to restrain the rectangular plate through the pre-cut aperture in a central area of the left half of the plate center.

13. The system for fastening solar panels to a slate roof of claim 9, wherein the at least two brackets comprise an open ended bracket comprising an aperture for receiving a fastener from above and located through the bottom half of the bracket for direct affixing to the solar panel.

14. The system for fastening solar panels to a slate roof of claim 9, wherein the at least two brackets comprise a twin aperture arrangement for receiving a set of fasteners from above and located through the bottom half of the bracket for direct affixing to the solar panel.

15. The system for fastening solar panels to a slate roof of claim 9, wherein the at least two brackets comprise a base mounting bracket comprising a compressed mid-section wherein an adjustment mechanism is passed through an aperture in the center of the base mounting bracket at the compressed mid-section.

16. The system for fastening solar panels to a slate roof of claim 15, wherein the at least two brackets comprise an upper bracket member, wherein the upper bracket member is threaded onto an adjustment mechanism so that it is perpendicular to the base mounting bracket.

17. The system for fastening solar panels to a slate roof of claim 16 wherein the end of the adjustment mechanism and the mounting mechanism are then utilized to attach the plate to the solar panels being installed.

18. The system for fastening solar panels to a slate roof of claim 9 wherein the material for the rectangular plate is selected from the group consisting of polymeric, metallic, alloy, composite, compound metallic-polymeric metal and composite.

19. The system for fastening solar panels to a slate roof of claim 9 the material for the rectangular plate is selected from the group consisting of polymeric, metallic, alloy, composite, compound metallic-polymeric metal and composite.
